(19) United States
(12) Patent Application Publication
(10) Pub. No.: US 2026/0140284 A1
(43) Pub. Date: May 21, 2026

(54) Display, Method for Projecting an Image and Method for Manufacturing a Display

(71) Applicants: Fraunhofer-Gesellschaft zur Förderung der angewandten Forschung e.V., München (DE); Friedrich-Schiller-Universität Jena, Jena (DE)

(72) Inventors: Rohan KUNDU, Jena (DE); Peter SCHREIBER, Jena (DE); Charlotte DACHROTH, Berlin (DE); Ole JESCHONNEK, Berlin (DE)

(21) Appl. No.: 19/449,871

(22) Filed: Jan. 15, 2026

Related U.S. Application Data
(63) Continuation of application No. PCT/EP2024/070655, filed on Jul. 22, 2024.

(30) Foreign Application Priority Data
Jul. 20, 2023 (DE) 10 2023 206 923.7

(51) Int. Cl. G02B 3/00; G02B 30/29

(52) U.S. Cl. CPC G02B 3/0056; G02B 3/0062; G02B 30/29

(57) ABSTRACT

A display for displaying an image comprises a condenser lens array having a plurality of condenser lenses; a projection lens array having a plurality of projection lenses; a plurality of optical channels which each comprise at least one condenser lens and one projection lens and are configured for projecting the image to be displayed by means of the display; and a plurality of collecting lenses arranged between optical paths of adjacent condenser lenses. A respective collecting lens is configured for collecting incident light and steering it to regions outside the projection lenses.

### CROSS-REFERENCES TO RELATED APPLICATIONS

This application is a continuation of copending International Application No. PCT/EP2024/070655, filed Jul. 22, 2024, which is incorporated herein by reference in its entirety, and additionally claims priority from German Application No. DE 10 2023 206 923.7, filed Jul. 20, 2023, which is incorporated herein by reference in its entirety.

The present invention relates to a display for displaying an image, to a system having such a display, to a method for projecting an image, and to a method for manufacturing an image. In particular, the present invention relates to a light-field device for 3D displays for direct view.

### BACKGROUND OF THE INVENTION

Light-field display offer glassless and fatigue-free 3D viewing. Compared to holographic methods, light-field displays require less computational effort and allow larger display sizes, see [1].

For such displays, the 3D image is displayed by reconstruction of a light-field. A typical architecture of such a light-field display is illustrated in FIG. 8a. A slide array 1002 containing the light-field information of a subject is illuminated. The elementary images 1004 projected by a lens (or lenslet) array 1006 overlap in the space before or behind the display in a region 1008, giving a 3D impression to an observer.

FIG. 8b shows a schematic front view of the light-field display 1000 in which the respective positioning of a slide 1004_{i,j} with i referring to the line and j referring to the column of the array relative to the projection lenses 1006_{i,j} is shown.

Examples of light-field displays relying on this architecture are described in [2]. However, there are disadvantages in this architecture.

For a light-field display, precise positioning of approximately ±1 pixel of the slide mask relative to the projection lenses is required over the whole array. In practice, the slide mask on the one hand and the lens array on the other hand are generated using different methods and then critically aligned and assembled. The tight assembly tolerances require specialized manufacturing techniques, for example replication in modified mask aligners [3] or advanced injection molding techniques [4].

Such specialized manufacturing techniques limit the size of the display and at the same time increase the cost which scales with the size of the display.

Consequently, displays allowing large sizes without significant extra expenditure and allowing high viewing quality would be desirable.

### SUMMARY

An embodiment may have a display for displaying an image, comprising: a condenser lens array comprising a plurality of condenser lenses; a projection lens array comprising a plurality of projection lenses; a plurality of optical channels which each comprise at least one condenser lens and one projection lens and are configured for projecting the image to be displayed by means of the display; a plurality of collecting lenses arranged between optical paths of adjacent condenser lenses; wherein a respective collecting lens is configured for collecting incident light and steering it to regions outside the projection lenses.

Another embodiment may have a system comprising a display in accordance with claim 1.

Another embodiment may have a method for manufacturing a display, comprising: manufacturing a condenser lens array comprising a plurality of condenser lenses and a projection lens array comprising a plurality of projection lenses; so that a plurality of optical channels each comprise at least one condenser lens and a projection lens and are configured for projecting the image to be displayed by means of the display; so that a plurality of collecting lenses are arranged between optical paths of adjacent condenser lenses; and so that a respective collecting lens collects incident light and steers it to regions outside the projection lenses.

In accordance with an embodiment, a display for displaying (or representing) a pattern comprises a condenser lens (or lenslet) array having a plurality of condenser lenses. The display comprises a projection lens array having a plurality of projection lenses and a plurality of optical channels which each comprise at least one condenser lens and one projection lens and are configured for projecting the image to be displayed by means of the display. The display comprises a plurality of collecting lenses arranged between optical paths of neighboring condenser lenses. A respective collecting lens is configured to collect incident light and to steer it to regions outside (or off) the projection lenses. By such steering outside the projection lenses, which, in embodiments, may comprise scattering or blocking light, it can be avoided that this light impedes the quality of the image. At the same time, these collecting lenses can be manufactured at the same time as the condenser and, if applicable, projection lenses, which avoids complicated positioning of the condenser lens array the projection lens array. Due to the avoided effort for aligning the two lens arrays, it is possible to also manufacture large displays without increasing costs.

In accordance with an embodiment, a method for projecting an image comprises illuminating a condenser lens array having a plurality of condenser lenses, in which at least one respective condenser lens, with a respective projection lens of a projection lens array, forms part of an optical channel, and the projection lenses are configured for projecting the image to be displayed by means of the display. The method comprises steering light from gaps between neighboring condenser lenses onto regions outside the optical channels.

In accordance with an embodiment, a method for manufacturing a display comprises manufacturing a condenser lens array having a plurality of condenser lenses and a projection lens array having a plurality of projection lenses. The method is executed such that a plurality of optical channels each comprise at least one condenser lens and one projection lens and are configured for projecting the image to be displayed by means of the display. The method is performed such that a plurality of collecting lenses is formed between optical paths of neighboring condenser lenses and a respective collecting lens collects incident light and steers it to regions outside the projection lenses.

### BRIEF DESCRIPTION OF THE DRAWINGS

Embodiments of the present invention will be detailed subsequently referring to the appended drawings, in which:

FIG. 1 is a schematic sectional side view of a display in accordance with an embodiment;

FIG. 2a is a schematic front view of at least part of a display in accordance with an embodiment having a two-dimensional arrangement of lenses;

FIG. 2b is a schematic sectional side view of the display of FIG. 2a;

FIG. 3 is a schematic sectional side view of at least part of a display in accordance with an embodiment, with non-imaging regions being arranged between opposite lens arrays and the non-imaging regions being buried relative to projection lenses;

FIG. 4a is a schematic sectional side view of a display in accordance with an embodiment in which at least a non-imaging region is arranged at a region elevated relative to a projection lens;

FIG. 4B is a schematic front view of the display of FIG. 4A,

FIG. 5 is a schematic block diagram of a system in accordance with an embodiment;

FIG. 6 is a schematic flow chart of a method for projecting an image in accordance with an embodiment;

FIG. 7 is a schematic flow chart of a method for manufacturing a display in accordance with an embodiment, and

FIG. 8a is a schematic sectional side view of a known light-field display; and

FIG. 8b is a schematic front view of the light-field display of FIG. 8a.

### DETAILED DESCRIPTION OF THE INVENTION

Before discussing below in greater detail embodiments of the present invention referring to the drawings, it is pointed out that identical elements, objects and/or structures or those of equal function or equal effect are provided with the same reference numerals in the different figures so that the description of these elements illustrated in different embodiments is mutually interchangeable or mutually applicable.

Embodiments described below are described in the context of a plurality of details. However, embodiments may also be implemented without these detailed features. Additionally, for reasons of understandability, embodiments are described using block circuit diagrams as a substitute for a detailed illustration. Additionally, details and/or features of individual embodiments may easily be combined with one another, unless the opposite is explicitly described.

The following embodiments refer to displays for displaying an image, at least one symbol or the like, to methods for projecting an image, and to methods for manufacturing a display. Some of the displays used here or manufactured displays may be referred to as light-field displays. However, embodiments of the present invention are not restricted to this, but also allow a different implementation of displays, for example as a projection display using a projection screen. This is not in conflict with some embodiments which are directed to the design of the display such that the display is configured to display at least parts of the image with a three-dimensional effect. This means that at least parts of the image are displayed such that they are apparently positioned in one or more different distances in front of or behind the display. In a three-dimensional light-field display for direct viewing, it may be of advantage for all the channels to display the signs visible at the corresponding position of the display. In accordance with an advantageous implementation, this may be distributed to small up to very small channel clusters of, for example, 5, 10, 15, 16 or the like optical channels. In advantageous implementations, a geometry of the channel cross section is selected, which allows a high area filling factors of the entire arrangement, for example a quadrangular or hexagonal geometry. In correspondence with a quadrangular or hexagonal array symmetry, channel clusters having a number of 4, 9, 16, . . . channels (quadrangular) or 3, 7, . . . channels (hexagonal) may prove to be useful or of advantage.

In the case of a screen projection, 3D information are not always lost but may become visible as, for example, blurring of the signs/pattern or image in other distances of displayed figures. The advantageous implementation of steering undesired light to different regions by means of collecting lenses consequently remains also for displays which are not implemented to be light-field displays.

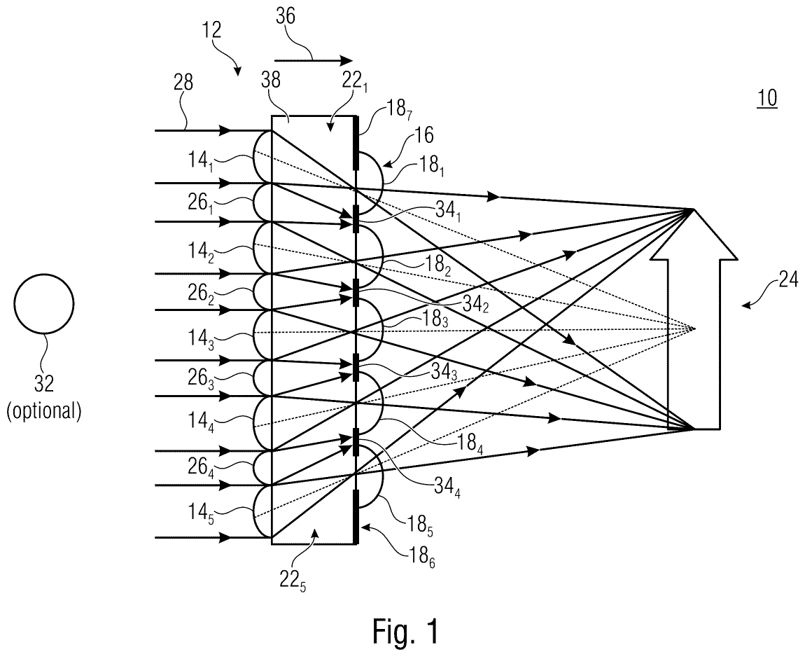

FIG. 1 shows a schematic sectional side view of a display 10 in accordance with an embodiment.

The display 10 comprises a condenser lens array 12 having a plurality of condenser lenses 14₁-14₅, wherein the number of condenser lenses 14 may be arranged in at least one column, at least one line or in any other one-dimensional or two-dimensional arrangement. A number of condenser lenses is as desired and is, for example, at least 3, at least 4, at least 5, at least 10 or more, approximately at least 20 or more.

Additionally, the display 10 comprises a projection lens array 16 having a plurality of projection lenses 18₁-18₅. A plurality of optical channels 22₁-22₅ may each comprise one of the condenser lenses 14 and an associated projection lens 18 and be configured for projecting the image 24 to be displayed by means of the display 10. The image 24 is, for example, an arrow, wherein any other images, patterns or pictures may also be projectable. As an alternative to arranging a single condenser lens 14 in an optical channel, a higher number of condenser lenses may also be arranged, which means that a single but also a higher number of condenser lenses may be associated to a projection lens. This configuration may be equal for all channels or differ from channel to channel. In the case of more condenser lenses, they may, for example, comprise different shapes for displaying different images or signs. Thus, embodiments are not limited to projecting a single image. In accordance with embodiments, the optical channels may be subdivided into at least a first subset for displaying a first image and at least a second subset for displaying a second image. The projection locations of the images may thus overlap to display overlapped images, or may be spatially separate from one another or disjoint. Different images of different optical channels or groups here may be configured in different colors. Using different colors may be used for color mixing of overlapping images. Alternatively, it is also easily possible to display the same or also mutually different images or patterns in different colors next to one another.

For displaying more complex overall images having at least two individual images, it is also possible to arrange optical channels together for commonly displaying a respective individual image in a cluster belonging to the respective individual image so that condenser lenses of the cluster are implemented to be equal or similar, for example. Alternatively or additionally, a subarray of optical channels forming at least part of the overall array may be formed, comprising adjacent channels, with condenser lenses maybe shaped to be mutually different in correspondence with different sub-images.

For color presentation, in the embodiments described here, there are two mutually different concepts which may nevertheless be combined with each other. As discussed above, embodiments provide for providing mixed arrays of different individual channels. In this case, channel-wise arrangement of color filters per channel as a component of the array may be of advantage, similarly to a Bayer pattern, for example. This configuration is of particular advantage for direct view displays. For arranging channel clusters, a spatial color segmentation of the collimated light source with corresponding color filters and/or using individually collimated light sources, like LEDs of different colors, is also possible.

At least one of a plurality of collecting lenses 26₁-26₄ may be arranged between the optical paths of adjacent condenser lenses 14₁ and 14₂; 14₂ and 14₃; 14₃ and 14₄ and/or 14₄ and 14₅. This applies both to adjacent condenser lenses of different optical channels and to condenser lenses of an equal optical channel. These are configured to collect incident light and steer it onto regions outside the projection lenses 18. The collecting lenses can achieve, at least partly, the object of keeping the incident light outside the projection region of the image 24, and may also be referred to as blocking lenses or blocker lenses. Collecting light may, for example, comprise at least partly focusing or bundling but this is not absolutely necessary. At least partly focusing or bundling incident light, however, allows an error tolerance relative to positioning imprecision relative to the target of the light caught and collected by the collecting lenses 26.

The display 10 is, for example, configured for receiving light 28 which may possibly but not necessarily be collimated and be provided by an optional light source 32. Thus, the light source 32 may be configured to provide the light 28 to the condenser lens array 12 as collimated light.

In a preferred embodiment, each of the plurality of condenser lenses 14 of the condenser lens array 12 is configured to image a light source illuminating the condenser lens, like the light source 32, into the projection lens 18 associated to the condenser lens. This may be understood to be Koehler illumination, for which collimated light may be used advantageously even if this is not absolutely necessary for implementing the invention.

In accordance with an embodiment, one or more of the collecting lenses 26 are configured to steer the incident light onto a non-imaging region 34₁-34₄ associated to the respective collecting lens. Each of the non-imaging regions may be implemented, individually or as a whole, as a light-absorbing region and/or light-scattering region or a combination thereof. At least one of the non-imaging regions 34₁-34₄ may comprise or form a light-absorbing region which comprises a metal layer arrangement, in particular, a chrome layer arrangement.

As is exemplarily illustrated in FIG. 1, embodiments provide for the condenser lens array 12 on the one hand and the projection lens array 16 on the other hand to be arranged on opposite sides of a lens substrate 38. Manufacturing, possibly simultaneously, the condenser lens array 12 and the projection lens array 16 and, optionally, the collecting lenses 26 allows precise and low-error positioning of the lenses relative to one another. However, this does not exclude that, in accordance with embodiments, the condenser lens array 12 on the one hand and the projection lens array 16 on the other hand are manufactured on an individual separate substrate, being assembled subsequently. This allows arranging non-imaging regions in a plane between the lens arrays 12 and 16, for example.

A precise position of the non-imaging regions 34 along an imaging direction 36, starting from a light source 32 towards the image 24, may be implemented in different ways. For example, as is illustrated in FIG. 1, a surface of the projection lens array 16 may serve as a ground area or deposition area for the non-imaging regions 34. Alternatively or additionally, non-imaging regions may also be provided between a plane of the condenser lens array 12 and a plane of the projection lens array 16, like in the form of an aperture structure or the like, which is arranged in the substrate 38 which supports the condenser lens array 12 and/or the projection lens array 16.

Alternatively or additionally, one or more of the non-imaging regions 34 may be arranged to be elevated relative to a plane of the projection lenses 18, which will be described below in greater detail. Additionally, using non-imaging regions is a way of implementing high-quality imaging of the image 24. It is also conceivable to steer light which is caught by the collecting lenses 26 onto regions outside the image 24 where it does not interfere in the image 24 either.

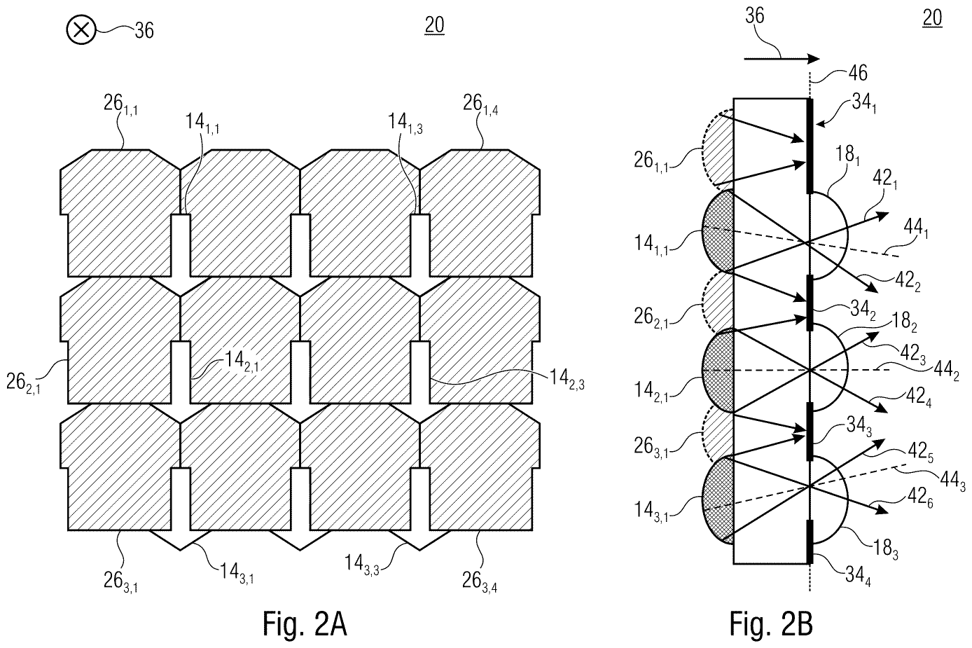

FIG. 2 shows a schematic front view of at least part of a display 20 in accordance with an embodiment. What is illustrated are the condenser lenses 14_{1,1}-14_{3,3} in an exemplary three-line and three-column matrix arrangement. The collecting lenses 26_{1,1}-26_{3,4} are arranged in gaps between the condenser lenses 14_{1,1}-14_{3,3}. Segmentation thereof into three columns and four lines is only exemplary and may, for example, be continued in additional lines and enclosing the condenser lenses 14_{3,1}-14_{3,3}. As is illustrated in FIG. 2a, it is possible in accordance with embodiments to implement the contour of the condenser lenses 14_{1,1}-14_{3,3} such that it matches with at least a sub-region of the image to be displayed by means of the display, like the image 24. The condenser lenses 14_{1,1}-14_{3,3} may also be referred to as shaper lenses. For example, the condenser lenses 14_{1,1}-14_{3,4} may each be formed as a decentered lens segment or comprise such a decentered lens segment. The collecting lenses 26_{1,1}-26_{3,4} may also be used to fill up regions between the condenser lenses 14_{1,1}-14_{3,3} and towards an edge of the display 20.

As is illustrated using the matching geometries of the condenser lenses 14_{1,1}-14_{3,3}, each of the optical channels of the display may be configured to display an elementary image of a plurality of matching elementary images. The plurality of optical channels is configured to image the plurality of elementary images in a projection plane, like a projection plane of a light-field display or a target region of a projection screen, to be overlapping, like in a region in which the image 24 is displayed and/or perceived by the observer with a three-dimensional effect, as is possible both for displays imaging onto a projection area and for light-field displays.

As is illustrated in FIG. 2a, the condenser lens array 12 may comprise an array of lenses of irregular edges, which may, for example, be adjusted to the part of the image, which is to be displayed.

FIG. 2b shows a schematic sectional side view of the display 20. By means of edge rays 42₁-42₆ and central rays 44₁-44₃, FIG. 2 illustrates that the condenser lenses 14_{1,1}-14_{3,1} are configured to focus the incident light in a plane 46 which corresponds to a plane of the projection lenses 18₁-18₃.

In other words, FIGS. 2a-b show the arrangement of an entrance lens array. The shaper lenses 14a consist of or include decentered lens segments to steer the incident light from a collimated light source towards the center of the openings of the projection lenses. Arbitrarily sized “blocking” lenses 26 are provided between the shaper lenses to direct light away from transmissive regions of the projection lenses, for example, by directing the light towards the middle of the non-imaging dead zones of the projection lens array which are, for example, covered by an absorbing aperture layer 34.

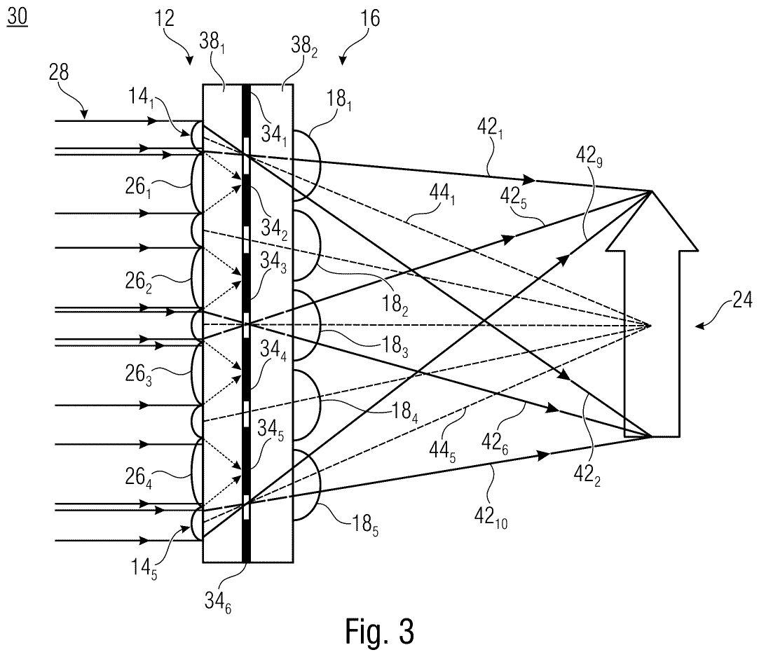

FIG. 3 shows a schematic sectional side view of at least part of a display 30 in accordance with an embodiment in which the condenser lens array 12, together with the collecting lenses 26₁-26₄, is arranged on a first lens substrate 38₁ or molded thereat. The projection lens array 16 is formed or shaped, for example, on a second lens substrate 38₂ and the non-imaging regions 34₁-34₆ which in this embodiment may also form apertures for the optical channels of the display 30, may be arranged between the substrates 38₁ and 38₂. The non-imaging regions may be arranged in a plane between the condenser lens array and the projection lens array 16. The display 30 differs from the display 10 by this, for example, since the non-imaging regions there may be arranged on or in the surface of the projection lens substrate in a gap between the adjacent projection lenses and thus on or in the same surface where the projection lenses 14 are arranged. In both cases, the non-imaging region 34 can define apertures of the projection lenses 14.

Although accepting relative positioning of the substrates 38₁ and 38₂, designing the collecting lenses 26₁-26₄ may be done easily in that an imaging plane of these lenses can be adjusted with high tolerances as long as the condenser lenses 14₁-14₅ allow imaging outside the non-imaging regions 34₁-34₆ and the light of the collecting lenses impinges on the non-imaging region.

One, more or all of the collecting lenses 26 of displays described herein can be configured to focus incident light 28 onto the associated non-imaging region within a tolerance range of 20%, 15%, particularly preferably 10% or less relative to the focal length of the collecting lens 26. In the implementation of the display 30, a requirement to this tolerance range may be more generous since, in relation, a greater area is available for catching the collected light.

As is illustrated in FIG. 1, and also in FIG. 3, some of the displays described herein may be configured such that a combination of the condenser lens array 12 and the collecting lenses defines an optically active entrance side of the display. It may cover the entrance side of the display to an extent of at least 90%, which means that at least 90% or more of light 28 incident on the display are fed to either a condenser lens or a collecting lens. This allows a particularly high efficiency, or low optical losses. In accordance with some embodiments, the plurality of collecting lenses 26 may be configured such that the amount of light incident on the plurality of collecting lenses is steered completely to the non-imaging regions 34, within a tolerance range of at most 10%, at most 7% or at most 5%, preferably less than 1%. In embodiments of displays described herein, the condenser lens array 12 and/or the projection lens array 16 may be formed as a micro lens array. This allows particularly good reproducibility of the displays.

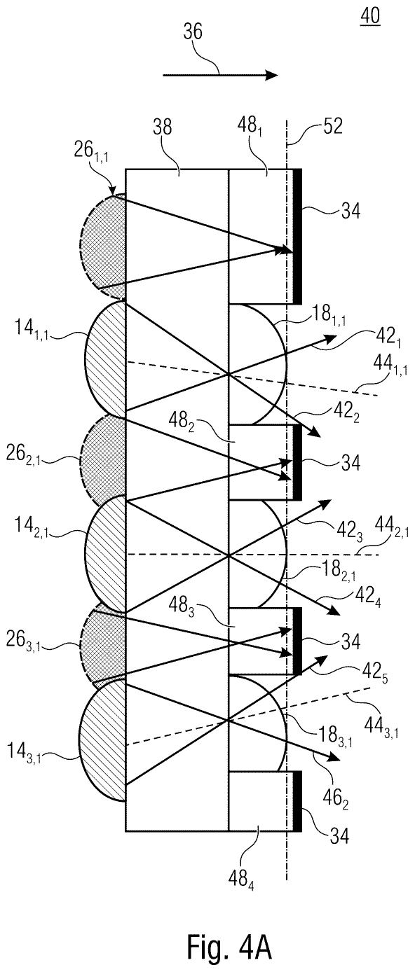

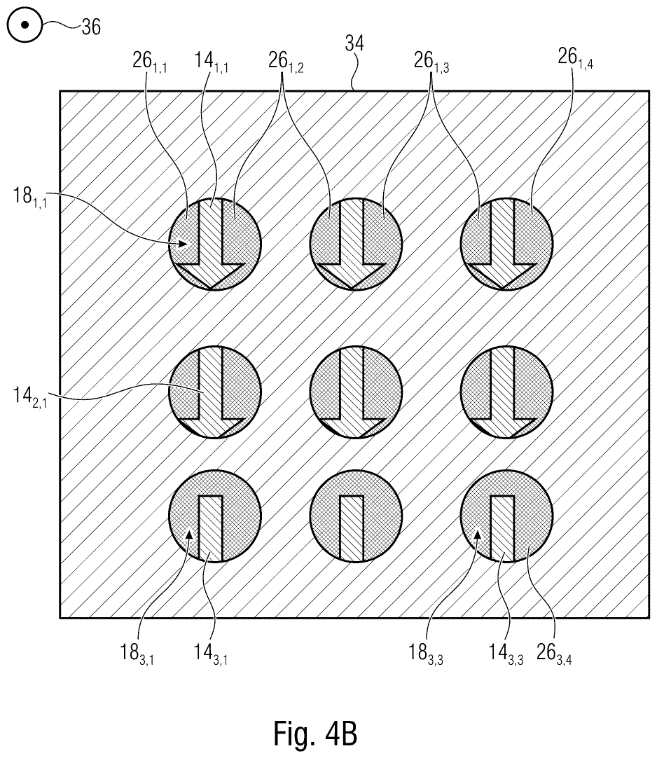

FIG. 4a shows a schematic sectional side view of a display in accordance with an embodiment. In the implementation of the display 40, the non-imaging regions 34 may be arranged at elevated regions 48₁-48₄, for example as a coating. The non-imaging regions 34 may, for example, be arranged as a colored layer. Thus, the elevated regions 48₁-48₄ may reach at least up to a height plane 52. The height plane 52 may be defined at least partly by vertices of the projection lenses 18 and describe a height by which the projection lenses 18 are elevated along the imaging direction 36 relative to the substrate 38. Preferably, the elevated regions 48₁-48₄ project beyond the height plane 52 at least slightly, which may make application of the non-imaging regions 34 or the colored layer or coating easier relative to a contamination of the projection lenses 18, which is to be avoided.

FIG. 4b shows a schematic front view of the display 40. It becomes obvious from FIG. 4b that the non-imaging region 34 and also the elevated regions 48₁-48₄ of FIG. 4a may be implemented as an integral region which is opened or interrupted by the apertures, or projection lenses 18_{1,1}-18_{3,3}.

The at least one elevated region 48 may be manufactured together with the projection lenses 18_{1,1}-18_{3,3}, for example within a same manufacturing process, like injection molding process. It is also possible to produce the at least one elevated region separately, maybe already with the non-imaging region 34, and to subsequently arrange it on the substrate 38, however, the complexity involved for precise alignment can be avoided.

In the implementation of the display 40, focusing of the light incident on the collecting lenses 26_{1,1}-26_{3,4} onto the at least one non-imaging region 34 may take place independently, as is illustrated, for example, for the collecting lens 26_{1,1}. However, this is not absolutely necessary, as is illustrated, for example, using the collecting lens 26_{3,1} which allows sufficiently avoiding stray light, also without focusing.

It is possible, but not necessary, for the non-imaging region 34 to define apertures for the optical channels. If, however, an opening angle of the condenser lenses 14 and/or of an associated projection lens 18 is unnecessarily large, the optical channel may be restricted by the non-imaging region 34.

The projection lenses 18_{1,1}-18_{3,1} may be formed as regular or as decentered lens segments, wherein implementation as a decentered lens segment produces advantages when steering the image, see, for example, projection lens 18_{3,1}.

Further implementations of the present invention which may also easily be employed in other displays described herein are discussed referring to FIGS. 4a and 4b. In accordance with an embodiment, at least one condenser lens of the condenser lens array may be configured to project a first subset of light incident on the condenser lens onto the associated projection lens and to steer a second subset of the incident light onto at least one non-imaging region arranged adjacent to the associated projection lens. Thus, at least one of the condenser lenses 14_{1,1}-14_{3,1} may not focus the incident light onto the associated projection lens 18_{1,1}-18_{3,3} completely, but, at least part of the incident light, onto the non-imaging region arranged adjacent to the projection lens 18_{1,1}-18_{3,1}. The resulting loss can be perceived in the displayed image as a gray level.

The respective condenser lens which is to be used for displaying a gray level may alternatively or in addition to steering the light onto the non-imaging region, comprise a diffuser formed from statistic roughness or deterministic micro-optical patterning of the condenser lens surface. Alternatively or additionally, a condenser lens may be formed as a free-form lens to couple out a corresponding portion of the light power via the lens geometry. Alternatively or additionally, it is also possible for one or more condenser lenses to comprise at least two or more condenser lens sub-regions, which may correspondingly functionally subdivide the area onto which the incident light impinges. Each of these solutions is suitable for separating the mentioned first subset from the second subset.

In accordance with embodiments of displays described herein, an arrangement of the condenser lenses and/or an arrangement of the projection lenses may comprise at least 6, at least 8 or more, approximately at least 20 lenses in an arrangement having at least three columns and at least two lines. Higher numbers of lenses, a higher number of columns and/or a higher number of lines is easily possible since larger displays may also be manufactured in a precise manner.

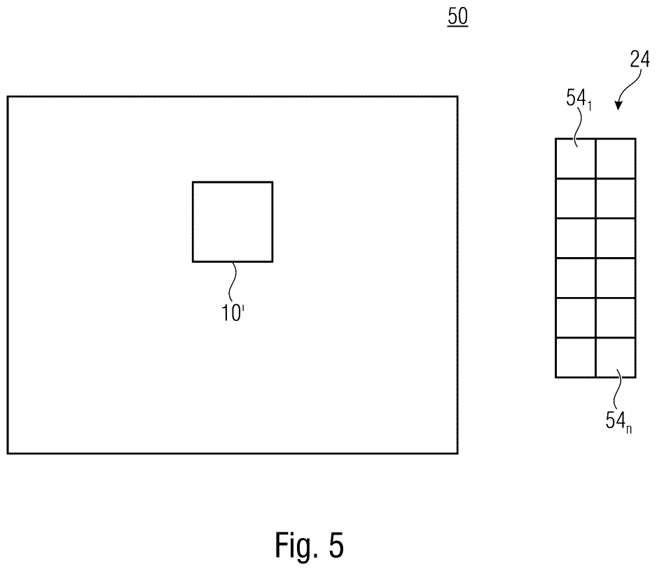

FIG. 5 shows a schematic block diagram of a system 50 in accordance with an embodiment, which may comprise a display 10′ described herein. The display 10′ may basically be formed to be matching with one of the displays 10, 20, 30 and/or 40, wherein the image 24 may, for example, be formed from one or more sub-images 54₁-54ₙ, with n≥1. Positioning of different sub-images 54₁-54ₙ relative to one another can be as desired and may be adjusted by the optics of the display. In accordance with an embodiment, a plurality of displays may be used here and/or a display may be configured for projecting several sub-regions of the overall image 24 to be displayed.

For example, the system 50 may be configured to provide or includes a touchless keyboard. The image 24 to be displayed may comprises keys of the keyboard which seem to float in front of the display. Thus, a respective sub-region 54₁-54ₙ may be associated to a key. Using a sensor device of the system 50, it may be recognized whether a user touches one of the sub-images 54₁-54ₙ or interacts with the sub-image 54 in another way, from which it can be derived in the system 50 that a key stroke has been triggered.

The touchless keyboard may be displayed as a floating structure, like freely floating in space, using the three-dimensional effect, for example.

An alternative implementation of the system 50 may, for example, relate to a rear light or a brake light or a different light device which may possibly, but not necessarily be mounted to a vehicle or may form part of such a vehicle. Such light emitting devices may be used to display one or more three-dimensional signs in a region of the, for example, automotive light. Thus, a logo, a warning message or a different piece of information may form at least part of the image to be displayed.

In accordance with an embodiment, the system 50 may also be configured as a vehicle light and be configured to display the image 24 for dynamically communicating with a different road user. For example, this may be a direction display, a change in velocity or different information. Preferably, this is displayed in front of a diffusely radiating background which is generated by scattering non-imaging regions. On the one hand, the far-field distributions required by light standards, for example, and 3D sign imaging may be realized together.

Displays described herein may, individually or in combination with other displays, be configured to display multi-component signs, symbols or graphics. Here, two possibilities are conceivable, among others. Several signs may be displayed by displaying an individual sign in each channel, or the different signs may be arranged to be distributed onto several channels. For the implementation as a so-called direct view (3D) display, it is of advantage to arrange the channels displaying the individual signs closely adjacent to one another, for example in analogy to a RGB Bayer pattern, as is explained in connection with FIG. 1. This is not required in the case of screen projection. Controlling the brightness of the individual signs may be controlled by the number of respective projecting channels used. This means that different sub-regions of the overall image or different sub-patterns of an overall pattern can be set with an equal or, for controlling brightness, different number of optical channels.

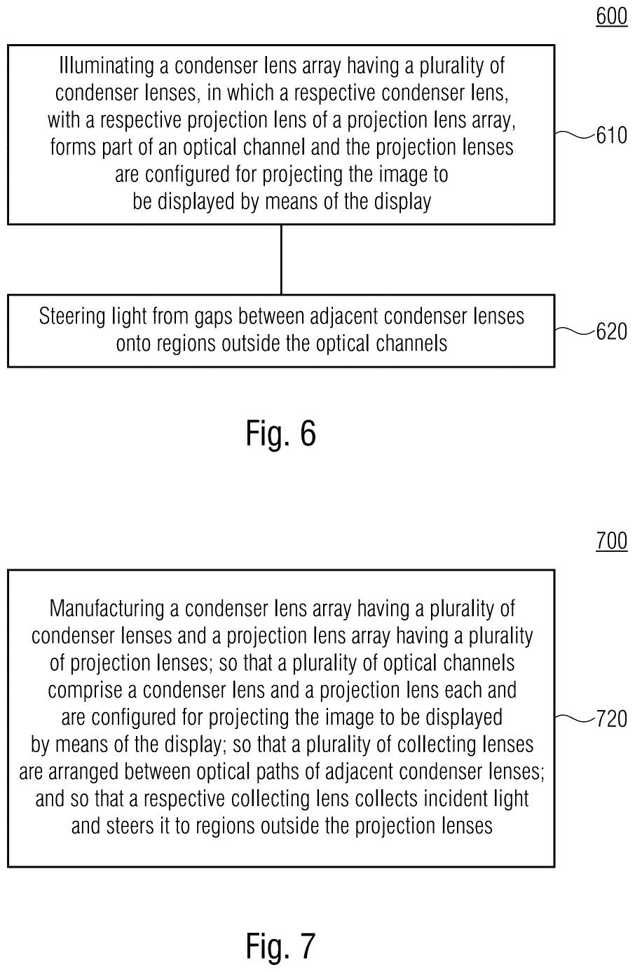

FIG. 6 shows a schematic flowchart of a method 600 for projecting an image in accordance with an embodiment. Step 610 comprises illuminating a condenser lens array having a plurality of condenser lenses, wherein a respective condenser lens, with a respective projection lens of a projection lens array, forms part of an optical channel, and the projection lenses are configured for projecting the image to be displayed by means of the display. Step 620 comprises steering light from gaps between adjacent condenser lenses onto regions outside the optical channels.

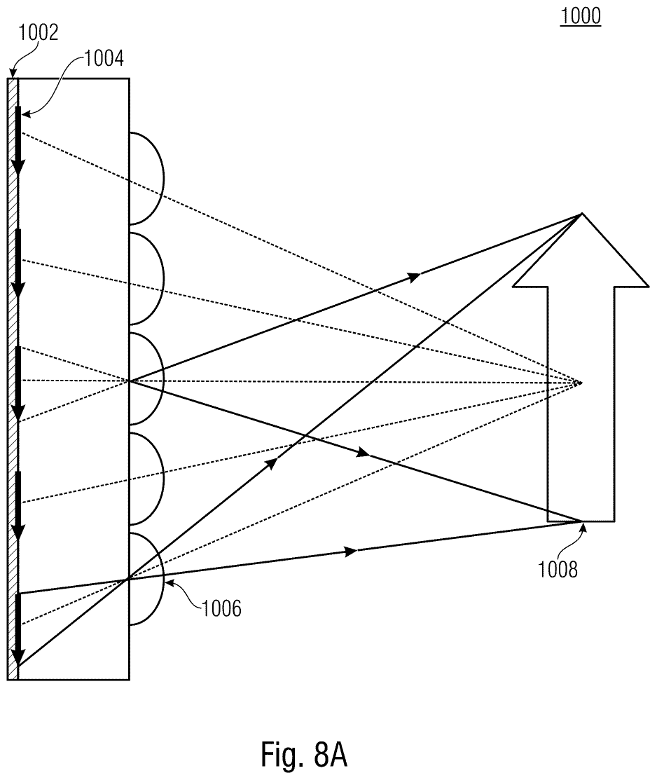

FIG. 7 shows a schematic flowchart of a method 700 in accordance with an embodiment. Step 710 comprises manufacturing a condenser lens array having a plurality of condenser lenses and a projection lens array having a plurality of projection lenses, like in separate production steps or a common production step. The method is executed such that a plurality of optical channels each comprise a condenser lens and a projection lens and are configured for projecting the image to be displayed by means of the display. The method is additionally executed such that a plurality of collecting lenses are arranged between optical paths of adjacent condenser lenses and such that a respective collecting lens collects incident light and steers it to regions outside the projection lenses.

Manufacturing 710 may particularly include an injection molding process. The method 700 may independently comprise, as another step, manufacturing non-imaging regions which may be mutually separate or continuous, as a target region of the collecting lenses by performing a coating process or coloring process onto regions of a projection lens substrate which are elevated relative to the projection lenses, as is discussed in connection with FIGS. 4a and 4b.

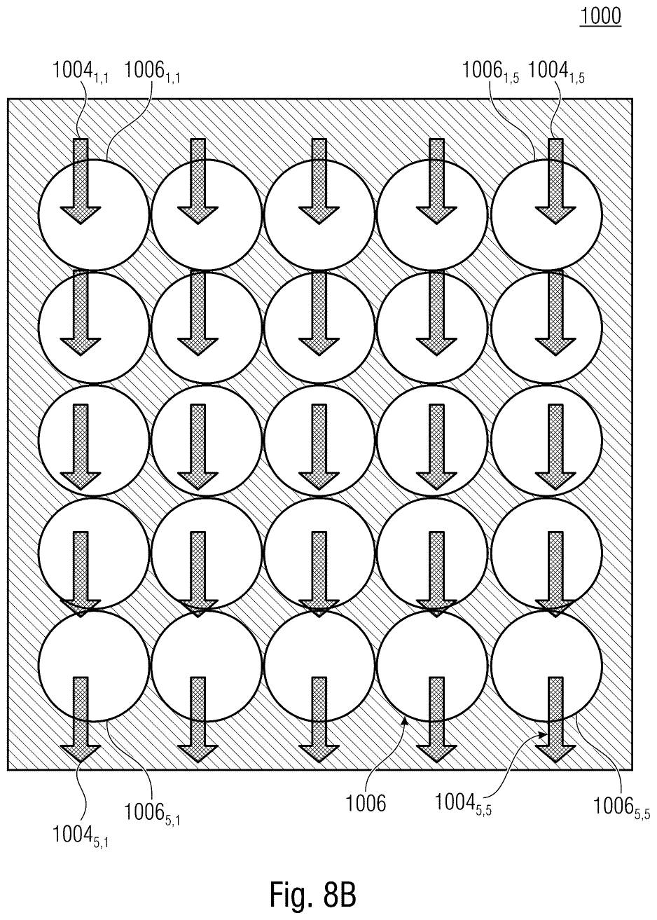

In other words, embodiments suggest a modified architecture of light-field displays or other displays in which the slide array shown in FIGS. 8a-b is formed by an array of irregularly shaped entrance or input lenses, i.e. condenser lenses and collecting lenses, to display the individual images or elementary images. This may result in a double-sided MLA (micro lens array) architecture as is illustrated, for example, in FIG. 1.

A display suggested here, like a light-field display, comprises an entrance array of irregularly shaped lenses 14/26 and an array of projection lenses 18 at the exit side. The elementary image for each channel is generated by a combination of condenser lenses or shaper lenses 14 and blocker regions 26. In the simplest case, these regions consist of only one lens. The shape of the aperture of the shaper lenses is identical to the geometry of the elementary images. The shaper lenses act as condenser lenses, which image the light source into the addressed projection lens, thus realizing Koehler illumination and enabling imaging of the shaper lens. In contrast, the blocker lenses direct the incoming light such that they are not imaged by the addressed projection lenses. This can be achieved, for example, by focusing the image of the light source onto blocking apertures or non-imaging regions 34, which are buried under the projection lenses, or elevated relative to the projection lenses, for example; or onto non-imaging plano regions between adjacent projection lenses with optional scattering behavior, or by directing light onto neighboring projection lenses. This last possibility is, however, not preferred because it will lead to channel crosstalk and generate unwanted ghost-like images.

Generally, it is of advantage or, in some embodiments, required for the contour of each shaper region to be identical with the contour of the image to be projected. This contour can be filled by one or more shaper lenses. This also applies to the blocking regions. Division into multiple shaper/blocker lenses may help to reduce lens sag, which facilitates manufacturing. For the sake of simplicity, it is assumed that one region is displayed by only a single lens. This is of advantage as regards homogeneity of the luminance (direct view display) or illuminance (projection display) of the image.

In analogy to FIGS. 8a-b, the projection lenses project the apertures of the shaper lenses towards the far field, see image 24 in FIG. 1.

Additionally, gray-levels in the displayed image can be produced by manipulating the light distribution of the shaper lenses such that only part of the incoming light is directed towards the imaging lens 18, while the remaining light is sent to a blocking region 34 between the projection lenses 18. This division into transmitted and blocked parts can be achieved, for example, by scattering diffusors onto the shaper lens, special freeform layouts distributing the light in a controlled manner, or by subdividing the lenses into multiple lenses, wherein some of them direct the light to the blocking dead zones, like in the case of a scanning half tone image.

By using an arrangement of specially shaped shaper-blocker regions, like at the entrance MLA, the function of a slide mask can be realized to be purely refractive, using the same manufacturing technique as that of the projection lenses.

To suppress the possibility of crosstalk and improve the resolution of the display, the aperture layer masking the dead spaces just below the projection lenses can be moved to an intermediate distance from the projection lenses and the entrance lens array to act like an aperture stop. Such a remote aperture stop introduces vignetting in the system by cutting away skew rays and improves the resolution of the projection system at the cost of transmission [5].

The schematic of a light-field display with such a remote aperture stop is shown in FIG. 3. Since the array of aperture stops 34 is further away from the projection lenses, stray light generated due to channel crosstalk or misalignment can be blocked effectively before the stray light reaches the projection lenses.

The precision requirements for the alignment of such a buried aperture stop with respect to the lens array is much lower (about one order of magnitude) than the required lateral positioning precision of elementary images relative to the addressed projection lens. The relaxed alignment tolerances enable easier manufacturing, for example by two-component plastic injection molding or injection molding with inserted metallic aperture sheet.

Embodiments of the invention offer, among other things, the following advantages:
Easier tolerances for alignment of two lens arrays with an optional aperture mask layer offer easier alignment and assembly.
Generating 3D motives by eliminating slide masks and using purely refractive elements with option of generating gray levels in displayed image.
Light-field display can be produced using simple injection molding techniques.
Simple, well-established manufacturing and assembly of micro-optics elements using gray-scale and reflow mastering processes.

Embodiments may be applied in, among other things:
Decorative art installations
3D icons/symbols for advertisement and branding, for example automotive exterior signage
General light shaping
3D effects in automotive turn indicators/rear light clusters.
Touchless interfaces for public buildings/surgery rooms.

Although some aspects were described in connection with an apparatus, it is to be understood that these aspects also represent a description of the corresponding method so that a block or element of an apparatus is to be understood to be also a corresponding method step or feature of a method step. In analogy, aspects described in connection with or as a method step also represent a description of a corresponding block or detail or element of a corresponding apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### References

[1] Park, J. H., Hong, K., & Lee, B. (2009). Recent progress in three-dimensional information processing based on integral imaging. Applied Optics, 48(34), H77-H94.
[2] S. Jensch et. al., DE102017210762A1—Lighting device for a motor vehicle, BMW AG, Realeyes GmbH.
[3] P. Dannberg et al., “Wafer-Level Hybrid Integration of Complex Micro-Optical Modules”, Micromachines 2014, 5, 325-40.
[4] F. von Laffert et. al., DE 102011000947A1—Flat 3D display unit, Realeyes GmbH.
[5] W. S. Smith, Modern Optical Engineering, 2^{nd} edition, 3.4 “The Effect of Lens Shape and Stop Position on the Aberrations”.

1. A display for displaying an image, comprising:
a condenser lens array comprising a plurality of condenser lenses;
a projection lens array comprising a plurality of projection lenses;
a plurality of optical channels which each comprise at least one condenser lens and one projection lens and are configured for projecting the image to be displayed by means of the display;
a plurality of collecting lenses arranged between optical paths of adjacent condenser lenses;
wherein a respective collecting lens is configured for collecting incident light and steering it to regions outside the projection lenses.

2. The display in accordance with claim 1, wherein at least a subset of the plurality of collecting lenses is configured to steer the incident light onto a non-imaging region, associated to the collecting lens, between projection lenses or between optical channels,
wherein the non-imaging region comprises a light-absorbing and/or light-scattering region.

3. The display in accordance with claim 2, wherein the non-imaging region is arranged at regions elevated relative to the plurality of projection lenses with respect to a plane of the projection lenses.

4. The display in accordance with claim 1, wherein the non-imaging region defines apertures of the projection lenses.

5. The display in accordance with claim 1, wherein the condenser lens array and the collecting lenses on the one hand and the projection lens array on the other hand are arranged on opposite sides of a lens substrate.

6. The display in accordance with claim 1, wherein the condenser lens array comprises an array of lenses comprising irregular edges.

7. The display in accordance with claim 1, wherein the plurality of optical channels comprises a first subset for displaying the image as a first image and a second subset for displaying a second image.

8. The display in accordance with claim 1, formed as a projection display and/or a light-field display; and/or
configured for displaying at least parts of the image with a three-dimensional effect.

9. The display in accordance with claim 1, wherein each optical channel of the plurality of optical channels is configured to display an elementary image of a plurality of matching elementary images; wherein the plurality of optical channels is configured to image the plurality of elementary images in a projection plane to be overlapping.

10. The display in accordance with claim 1, wherein each of the plurality of condenser lenses is configured to image a light source illuminating the condenser lens into the projection lens associated to the condenser lens.

11. The display in accordance with claim 1, wherein at least a subset of the projection lenses is formed as a decentered lens segment.

12. The display in accordance with claim 1, wherein at least one condenser lens of the condenser lens array is configured to project a first subset of light incident on the condenser lens onto the associated projection lens and to steer a second subset of the incident light onto at least one non-imaging region arranged adjacent to the associated projection lens.

13. The display in accordance with claim 1, comprising a light source configured to provide to the condenser lens array collimated light as the incident light.

14. The display in accordance with claim 1, wherein an arrangement of the condenser lenses and/or an arrangement of the projection lenses comprise at least 6 lenses in an arrangement comprising at least three columns and at least two lines.

15. A system comprising a display in accordance with claim 1.

16. The system in accordance with claim 15, comprising a plurality of displays or a display comprising a plurality of sub-regions configured for projecting different sub-regions of an overall image to be displayed.

17. The system in accordance with claim 15, comprising a touchless keyboard in which the image to be displayed comprises keys of the keyboard.

18. The system in accordance with claim 15, comprising an automotive light, in particular a rear light or break light, and wherein the image is a three-dimensional sign in a region of the automotive light; or
configured as a vehicle light and configured for dynamically displaying the image for communicating with another road user.

19. A method for manufacturing a display, comprising:
manufacturing a condenser lens array comprising a plurality of condenser lenses and a projection lens array comprising a plurality of projection lenses;
so that a plurality of optical channels each comprise at least one condenser lens and a projection lens and are configured for projecting the image to be displayed by means of the display;
so that a plurality of collecting lenses are arranged between optical paths of adjacent condenser lenses; and
so that a respective collecting lens collects incident light and steers it to regions outside the projection lenses.

20. The method in accordance with claim 19, comprising:
producing at least one non-imaging region as a target region of the collecting lenses by executing a coating process on a region of a projection lens substrate, which is elevated relative to the projection lenses.
